(19) United States
(12) Patent Application Publication
(10) Pub. No.: US 2019/0273458 A1
(43) Pub. Date: Sep. 5, 2019

(54) SENSOR FAULT DETECTION METHOD, MOTOR DRIVE SYSTEM, AND ELECTRIC POWER STEERING SYSTEM

(71) Applicant: NIDEC CORPOPRATION, Kyoto (JP)

(72) Inventor: Ahmad GHADERI, Kyoto (JP)

(73) Assignee: Nidec Corporation, Kyoto (JP)

(21) Appl. No.: 16/320,546

(22) PCT Filed: Jul. 21, 2017
(86) PCT No.: PCT/JP2017/026434

§ 371 Date: Jan. 25, 2019

(30) Foreign Application Priority Data
Jul. 28, 2016 (JP) 2016-148130

(51) Int. Cl. H02P 21/13; H02P 21/18; H02P 21/22; H02P 21/36; B62D 5/04

(52) U.S. Cl. CPC H02P 21/13; H02P 21/18; B62D 5/0484; H02P 21/36; B62D 5/049; H02P 21/22

(57) ABSTRACT

A sensor fault detection method for detecting a fault of at least one sensor in a motor drive system includes performing a calculation (A) to determine a counter electromotive force error Ver relative to an αβ fixed coordinate system or a dq rotating coordinate system. The calculation (A) is performed based on currents Iα and Iβ on αβ axes in the αβ fixed coordinate system, reference voltages Vα* and Vβ* on the αβ axes, and an electrical angle θₑ of a rotor. The counter electromotive force error Ver represents a function of an error between an estimated phase angle ρₛ and a measured phase angle ρ based on sensor values to be measured by the sensors. The method also includes detecting the fault based on the counter electromotive force error Ver.

### BACKGROUND OF THE INVENTION

### 1. Field of the Invention

The present disclosure relates to a sensor fault detection method for use in a motor drive system, a motor drive system, and an electric power steering system.

### 2. Description of the Related Art

Recently, an electric drive system has been widely used for various applications. A non-limiting example of the electric drive system is a motor drive system. For example, the motor drive system controls an electric motor (hereinafter, referred to as a “motor”) by vector control. Some current sensors and angle sensors have been utilized in the vector control. If one of these sensors fails, the motor drive system malfunctions, and consequently the motor drive system cannot recover in many instances. Therefore, there have been actively proposed various methods for detecting a sensor fault in a motor drive system.

According to the related art described above, a computer bears a large load of calculation for sensor fault detection. Therefore, it has been required to further reduce the load of calculation.

### SUMMARY OF THE INVENTION

An exemplary embodiment of the present disclosure provides a novel sensor fault detection method capable of reducing a calculation load for sensor fault detection on a computer, and a motor drive system using the sensor fault detection.

A sensor fault detection method according to an exemplary embodiment of the present disclosure is a method for detecting a fault of at least one of a plurality of sensors in a motor drive system. The method includes a step of performing a calculation (A) to determine a counter electromotive force error Ver relative to an αβ fixed coordinate system or a dq rotating coordinate system, wherein the calculation (A) is performed based on currents Iα and Iβ on αβ axes in the αβ fixed coordinate system, reference voltages Vα*and Vβ* on the αβ axes, and an electrical angle θₑ of a rotor, and the counter electromotive force error Ver represents a function of an error between an estimated phase angle ρₛ and a measured phase angle ρ based on sensor values to be measured by the sensors; and a step of detecting the fault, based on the counter electromotive force error Ver.

A motor drive system according to an exemplary embodiment of the present disclosure includes a motor including three-phase wires; at least two current sensors to detect at least two of three-phase currents; an angle sensor to detect a rotor angle of the motor; and a controller configured or programmed to control the motor and to detect a fault of at least one of the at least two current sensors as well as the angle sensor. The controller calculates a counter electromotive force error Ver relative to an αβ fixed coordinate system or a dq rotating coordinate system, based on currents Iα and Iβ on αβ axes in the αβ fixed coordinate system, reference voltages Vα* and Vβ* on the β⊕ axes, and the rotor angle, the counter electromotive force error Ver representing a function of an error between an estimated phase angle ρₛ and a measured phase angle ρ based on sensor values to be measured by the sensors. The controller detects the fault, based on the counter electromotive force error Ver.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic block diagram of a hardware configuration of a motor drive system 1000 using sensor fault detection according to a first exemplary embodiment of the present disclosure.

FIG. 2 is a schematic block diagram of a hardware configuration of an inverter 300 in the motor drive system 1000 using the sensor fault detection according to the first exemplary embodiment of the present disclosure.

FIG. 3 is a schematic block diagram of a hardware configuration of the motor drive system 1000 according to a modification of the first exemplary embodiment of the present disclosure.

FIG. 4 is a schematic functional block diagram of a functional block of a controller 100.

FIG. 5 is a schematic functional block diagram of a more specific functional block of a fault detection core unit 100A_1.

FIG. 6 is a schematic functional block diagram of a more specific functional block of the fault detection core unit 100A_1 according to a modification of an exemplary embodiment of the present disclosure.

FIG. 7 is a waveform chart of a torque within a predetermined period of time according to a first case.

FIG. 8 is a waveform chart of an actual rotor angle and a mechanical angle θₘ of a rotor, the mechanical angle θₘ being measured by an angle sensor 700, within the predetermined period of time according to the first case.

FIG. 9 is a waveform chart of a current I_{q} within the predetermined period of time according to the first case.

FIG. 10 is a waveform chart of a current I_{d} within the predetermined period of time according to the first case.

FIG. 11 is a waveform chart of currents Iₐ, I_{b}, and I_{c} within the predetermined period of time according to the first case.

FIG. 12 is a waveform chart of a counter electromotive force error Ver and a maximum acceptable error Vermax within the predetermined period of time according to the first case.

FIG. 13 is a waveform chart of a torque within a predetermined period of time according to a second case.

FIG. 14 is a waveform chart of an actual rotor angle and a mechanical angle θₘ of the rotor, the mechanical angle θₘ being measured by the angle sensor 700, within the predetermined period of time according to the second case.

FIG. 15 is a waveform chart of a current I_{q} within the predetermined period of time according to the second case.

FIG. 16 is a waveform chart of a current I_{d} within the predetermined period of time according to the second case.

FIG. 17 is a waveform chart of currents Iₐ, I_{b}, and Iₘ within the predetermined period of time according to the second case.

FIG. 18 is a waveform chart of a counter electromotive force error Ver and a maximum acceptable error Vermax within the predetermined period of time according to the second case.

FIG. 19 is a waveform chart of a torque within a predetermined period of time according to a third case.

FIG. 20 is a waveform chart of an actual rotor angle and a mechanical angle θₘ of the rotor, the mechanical angle θₘ being measured by the angle sensor 700, within the predetermined period of time according to the third case.

FIG. 21 is a waveform chart of a current I_{q} within the predetermined period of time according to the third case.

FIG. 22 is a waveform chart of a current I_{d} within the predetermined period of time according to the third case.

FIG. 23 is a waveform chart of currents Iₐ, I_{b}, and Iₘ within the predetermined period of time according to the third case.

FIG. 24 is a waveform chart of a counter electromotive force error Ver and a maximum acceptable error Vermax within the predetermined period of time according to the third case.

FIG. 25 is a waveform chart of a torque within a predetermined period of time according to a fourth case.

FIG. 26 is a waveform chart of an actual rotor angle and a mechanical angle θₘ of the rotor, the mechanical angle θₘ being measured by the angle sensor 700, within the predetermined period of time according to the fourth case.

FIG. 27 is a waveform chart of a current I_{q} within the predetermined period of time according to the fourth case.

FIG. 28 is a waveform chart of a current I_{d} within the predetermined period of time according to the fourth case.

FIG. 29 is a waveform chart of currents Iₐ, I_{b}, and Iₘ within the predetermined period of time according to the fourth case.

FIG. 30 is a waveform chart of a counter electromotive force error Ver and a maximum acceptable error Vermax within the predetermined period of time according to the fourth case.

FIG. 31 is a graph of a relationship between a composite magnetic flux Ψₛ and an estimated phase angle ρₛ.

FIG. 32 is a schematic functional block diagram of a more specific functional block of a fault detection core unit 100A_1 according to a second exemplary embodiment of the present disclosure.

FIG. 33 is a schematic diagram of a typical configuration of an EPS system 2000 according to a third exemplary embodiment of the present disclosure.

### DETAILED DESCRIPTION OF THE PREFERRED EMBODIMENTS

With reference to the accompanying drawings, hereinafter, a specific description will be given of a sensor fault detection method, a motor drive system employing sensor fault detection, and an electric power steering system including the motor drive system, according to an embodiment of the present disclosure. However, a specific description more than necessary will be occasionally omitted in order to avoid making the following description redundant more than necessary and to facilitate the understanding of a person skilled in the art. For example, a specific description on a well-known matter will be omitted occasionally. In addition, a repetitive description on substantially identical configurations will also be omitted occasionally.

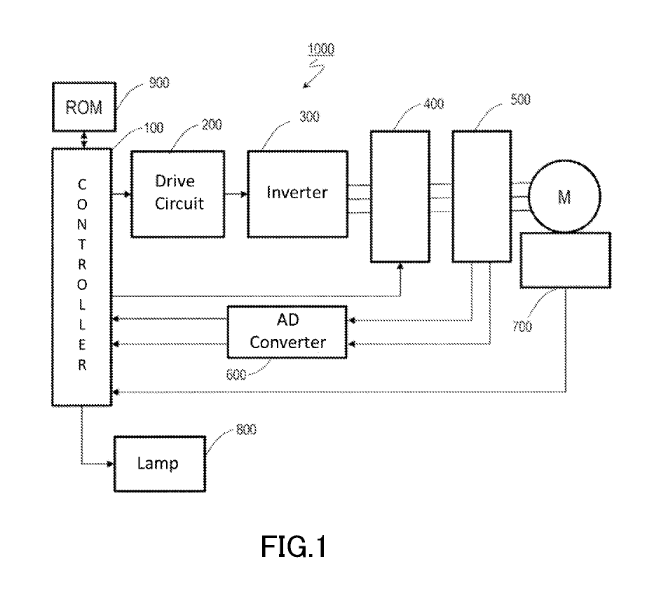

FIG. 1 schematically illustrates hardware blocks of a motor drive system 1000 employing sensor fault detection according to a first embodiment.

The motor drive system 1000 typically includes a motor M, a controller 100, a drive circuit 200, an inverter (also referred to as an “inverter circuit”) 300, a shutdown circuit 400, a plurality of current sensors 500, an analog-to-digital conversion circuit (hereinafter, referred to as an “AD converter”) 600, an angle sensor 700, a lamp 800, and a read only memory (ROM) 900. For example, the motor drive system 1000 may be designed in modules as a power pack, and may be manufactured and sold in the form of a motor module including a motor, a sensor, a driver, and a controller. It should be noted herein that the motor drive system 1000 will be described as an exemplary system including as its constituent the motor M. Alternatively, the motor drive system 1000 may be a system excluding as its constituent the motor M, the system being configured to drive the motor M.

Examples of the motor M may include a permanent magnet synchronous motor, such as a surface permanent magnet synchronous motor (SPMSM) or an interior permanent magnet synchronous motor (IPMSM), and a three-phase alternating-current motor. For example, the motor M includes three-phase (i.e., U phase, V phase, W phase) wires (not illustrated). The three-phase wires are electrically connected to the inverter 300.

For example, the controller 100 is a micro control unit (MCU). Alternatively, the controller 100 may be a field programmable gate array (FPGA) in which a CPU core is incorporated.

The controller 100 controls the entire motor drive system 1000, and controls the torque and rotational speed of the motor M by, for example, vector control. The rotational speed (unit: rpm) is expressed by the number of revolutions of a rotor per unit time (e.g., one minute). The vector control is a method of decomposing a current flowing through a motor into a current component contributing to generation of a torque and a current component contributing to generation of a magnetic flux, and independently controlling the current components that are perpendicular to each other. For example, the controller 100 sets a target current value in accordance with actual current values measured by the current sensors 500, a rotor angle measured by the angle sensor 700 (i.e., an output signal from the angle sensor 700), and others. The controller 100 generates a pulse width modulation (PWM) signal, based on the target current value, and then outputs the PWM signal to the drive circuit 200.

The controller 100 detects the fault of at least one of the current sensors 500 as well as the angle sensor 700. It should be noted that a method of detecting a sensor fault will be specifically described later. When the controller 100 detects a sensor fault, then the controller 100 generates at least one of, for example, a shutdown signal and a notification signal. The controller 100 outputs the shutdown signal to the shutdown circuit 400, and outputs the notification signal to the lamp 800. For example, a state in which no sensor fault occurs corresponds to a state in which both the shutdown signal and the notification signal are negated. When the controller 100 detects a sensor fault, then the controller 100 asserts each of the shutdown signal and the notification signal.

For example, the drive circuit 200 is a gate driver. The drive circuit 200 generates a control signal for controlling the switching operation of a switching element in the inverter 300, in accordance with a PWM signal to be output from the controller 100. It should be noted that the drive circuit 200 may be incorporated in the controller 100 as will be described later.

For example, the inverter 300 converts, into alternating-current power, direct-current power to be supplied from a direct-current power source (not illustrated), and then drives the motor M with the converted alternating-current power. For example, the inverter 300 converts direct-current power into three-phase alternating-current power of U-phase, V-phase, and W-phase pseudo sine waves, based on a control signal to be output from the drive circuit 200. The three-phase alternating-current power thus converted is used for driving the motor M.

For example, the shutdown circuit 400 includes a semiconductor switch element, such as a field-effect transistor (FET, typically a metal-oxide-semiconductor FET (MOSFET)) or an insulated gate bipolar transistor (IGBT), or a mechanical relay. The shutdown circuit 400 is electrically connected between the inverter 300 and the motor M. The shutdown circuit 400 interrupts the electrical connection between the inverter 300 and the motor M, in accordance with the shutdown signal to be output from the controller 100. More specifically, the shutdown signal when being asserted turns off the semiconductor switch element of the shutdown circuit 400, and interrupts the electrical connection between the inverter 300 and the motor M. Consequently, the shutdown circuit 400 stops power supply from the inverter 300 to the motor M.

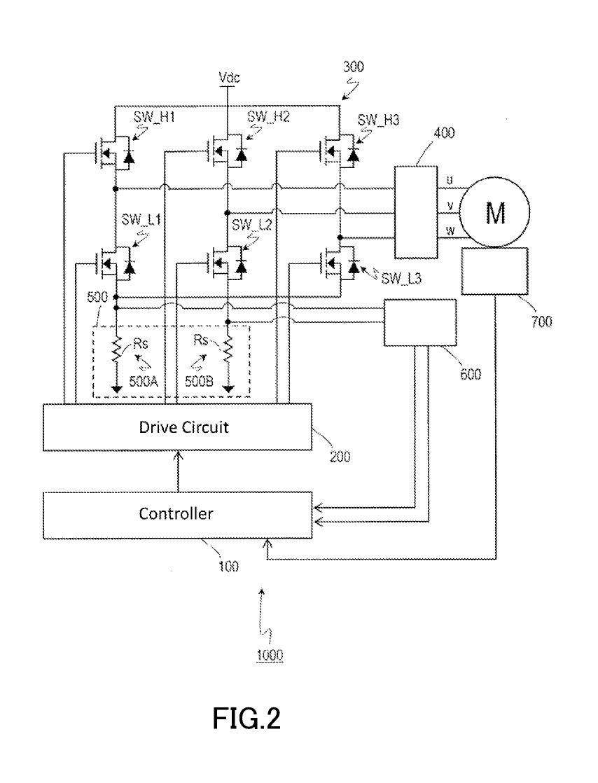

The current sensors 500 include at least two current sensors that detect at least two of currents flowing through U-phase, V-phase, and W-phase wires of the motor M. In the first embodiment, the current sensors 500 include two current sensors 500A and 500B (see FIG. 2) that respectively detect currents flowing through the U-phase and V-phase wires. Naturally, the current sensors 500 may include three current sensors that respectively detect three currents flowing through the U-phase, V-phase, and W-phase wires. Alternatively, the current sensors 500 may include two current sensors that respectively detect currents flowing through the V-phase and W-phase wires or currents flowing through the W-phase and U-phase wires. For example, each current sensor includes a shunt resistor, and a current detection circuit (not illustrated) that detects a current flowing through the shunt resistor. For example, the shunt resistor has a resistance value of about 0.1Ω.

The AD converter 600 converts by sampling, into digital signals, analog signals to be output from the current sensors 500, and then outputs the converted digital signals to the controller 100. Alternatively, the controller 100 may perform such AD conversion. In this situation, the current sensors 500 directly output analog signals to the controller 100.

The angle sensor (also referred to as a “position sensor”) 700 is disposed on the motor M, and detects a rotor angle of the motor M, that is, a mechanical angle of the rotor. Examples of the angle sensor 700 may include a magnetic sensor including a magnetoresistive (MR) element, a resolver, a rotary encoder, a Hall IC (including a Hall element), and the like. The angle sensor 700 outputs a mechanical angle of the rotor to the controller 100. The controller 100 thus acquires the mechanical angle of the rotor.

The motor drive system 1000 may include, for example, a speed sensor or an acceleration sensor, instead of the angle sensor 700. In cases where a speed sensor is employed in place of the angle sensor, the controller 100 subjects a rotational speed signal or an angular velocity signal to, for example, integration processing, thereby calculating a position of the rotor, that is, an angle of rotation of the rotor. An angular velocity (unit: rad/s) is expressed by an angle of rotation of the rotor per second. In cases where an acceleration sensor is employed in place of the angle sensor, the controller 100 subjects an angular acceleration signal to, for example, integration processing, thereby calculating an angle of rotation of the rotor. As used herein, the angle sensor may include any sensor configured to acquire a rotor angle. Examples of the angle sensor may include the magnetic sensor, the speed sensor, and the acceleration sensor each described above. In addition, the term “acquire” involves, for example, receiving a mechanical angle of a rotor from the outside, and acquiring a mechanical angle of a rotor in such a manner that the controller 100 calculates the mechanical angle.

For example, the lamp 800 includes a light emitting diode (LED). For example, when the controller 100 asserts a notification signal, the lamp 800 lights up red in response to this assertion. For example, consideration is given to a situation in which the motor drive system 1000 is installed in a vehicle. In this situation, the lamp 800 may be mounted on an instrument panel of a dashboard in addition to meters such as a speedometer and a tachometer.

Examples of the ROM 900 may include a programmable memory (e.g., a programmable read only memory (PROM)), a reprogrammable memory (e.g., a flash memory), and a read-only memory. The ROM 900 stores therein a control program including a group of commands that cause the controller 100 to control the motor M. For example, in booting the motor drive system 1000, the control program is once developed onto a random access memory (RAM) (not illustrated). It should be noted that the ROM 900 is not necessarily disposed outside the controller 100 as an external unit, but may be incorporated in the controller 100. For example, the controller 100, in which the ROM 900 is incorporated, may be the MCU described above.

With reference to FIG. 2, a more specific description will be given of a hardware configuration of the inverter 300.

FIG. 2 schematically illustrates the hardware configuration of the inverter 300 in the motor drive system 1000 employing the sensor fault detection according to the first embodiment.

The inverter 300 includes three lower-arm switching elements and three upper-arm switching elements. In FIG. 2, switching elements SW_L1, SW_L2, and SW_L3 correspond to the lower-arm switching elements, and switching elements SW_H1, SW_H2, and SW_H3 correspond to the upper-arm switching elements. Examples of each switching element may include a FET and an IGBT. Each switching element includes a freewheeling diode that allows a flow of regenerative current toward the motor M.

FIG. 2 illustrates shunt resistors Rs of the two current sensors 500A and 500B that respectively detect currents flowing through the U-phase and V-phase wires. As illustrated in FIG. 2, for example, the shunt resistors Rs may be electrically connected between the lower-arm switching elements and the ground. Alternatively, for example, the shunt resistors Rs may be electrically connected between the upper-arm switching elements and the power source.

For example, the controller 100 performs three-phase energization control using the vector control, thereby driving the motor M. For example, the controller 100 generates a PWM signal for the three-phase energization control, and outputs the PWM signal to the drive circuit 200. The drive circuit 200 generates, based on the PWM signal, a gate control signal for controlling the switching operation of each FET in the inverter 300, and then sends the gate control signal to the gate of each FET.

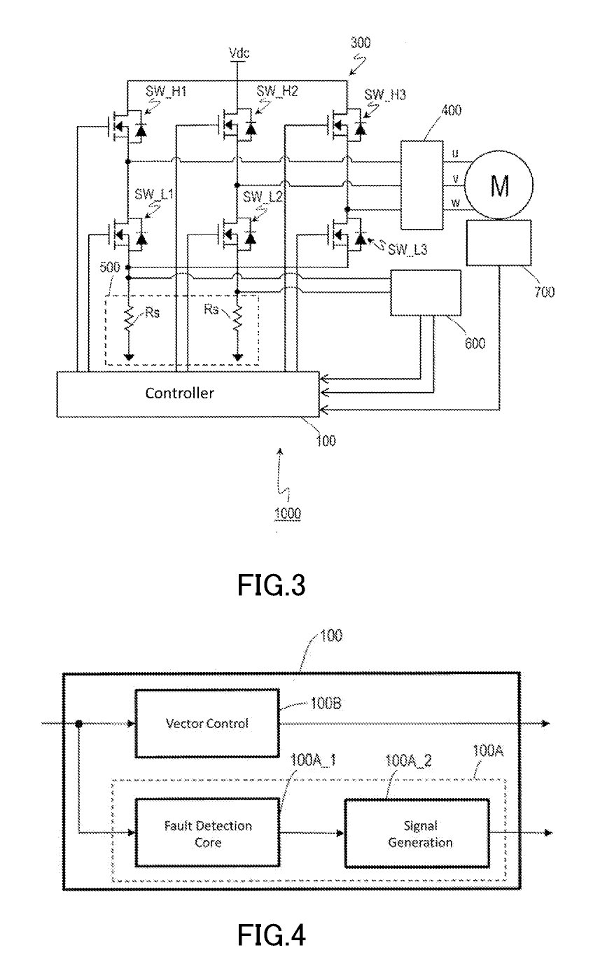

FIG. 3 schematically illustrates hardware blocks of the motor drive system 1000 according to a modification of the first embodiment.

As illustrated in FIG. 3, the motor drive system 1000 does not necessarily include the drive circuit 200. In this situation, the controller 100 includes ports for directly controlling the switching operations of the respective FETs in the inverter 300. Specifically, the controller 100 generates a gate control signal based on a PWM signal. The controller 100 outputs the gate control signal through each port, thereby sending the gate control signal to the gate of each FET.

Prior to a description of an algorithm of sensor fault detection, first, a description will be given of a sensor fault according to an embodiment of the present disclosure. The sensor fault includes a fault of the angle sensor 700 and a fault of each of the current sensors 500. For example, a magnetic sensor is widely used as the angle sensor 700 in the motor drive system 1000 for an electric power steering (EPS) system in an automobile. In the first embodiment, for example, a sensor magnet is formed by injection molding on a shaft of a motor. For example, the magnetic sensor is mounted on a circuit board (not illustrated) for the motor. As the shaft rotates, the sensor magnet also rotates. Therefore, the magnetic sensor detects a change in magnetic flux caused by a change in position of the magnetic pole.

Typically, the sensor magnet is firmly fixed to the shaft. However, if a vehicle such as an automobile undergoes any strong impact from the outside (e.g., an impact to be caused when a vehicle runs up onto a curb), this impact is transmitted to the shaft, which may result in breakage or deformation of the sensor magnet. Alternatively, this impact may cause positional displacement of the sensor magnet. The breakage, deformation, or positional displacement makes the magnetic sensor difficult to accurately detect a position of a rotor. As used herein, the fault of the angle sensor includes not only a fault of an angle sensor, but also a breakage of a sensor magnet. In addition, the fault of the current sensor includes a breakage of a shunt resistor.

If necessary, it is preferable to avoid continuously driving the EPS system in a state in which a sensor fault occurs at the motor drive system 1000. For example, if a sensor fault occurs, stopping the EPS system, that is, stopping the motor drive system 1000 improves the safety of the EPS system. As described above, it is important to detect a sensor fault in the motor drive system 1000 that particularly requires safety.

With reference to FIGS. 4 to 6, a specific description will be given of the algorithm of sensor fault detection according to the first embodiment.

The algorithm of sensor fault detection according to the first embodiment may be implemented with only hardware such as an application specific integrated circuit (ASIC) or a FPGA, or may be implemented by a combination of hardware with software.

FIG. 4 schematically illustrates functional blocks of the controller 100. As used herein, each block is not illustrated on a hardware basis, but is illustrated on a functional block basis in the functional block diagram. For example, the software may be a module constituting a computer program for executing specific processing corresponding to each functional block.

For example, the controller 100 includes a fault detection unit 100A and a vector control unit 100B. As used herein, each functional block is referred to as a “unit” for convenience of the description. Naturally, the term “unit” is not used to limit and interpret each functional block to and as hardware or software.

The fault detection unit 100A includes a fault detection core unit 100A_1 and a signal generation unit 100A_2. The fault detection core unit 100A_1 is a core of sensor fault detection. The fault detection core unit 100A_1 performs calculation for determining a counter electromotive force error Ver relative to an αβ fixed coordinate system or a dq rotating coordinate system. The fault detection core unit 100A_1 performs the calculation, based on currents Iα and Iβ on the αβ axes in the αβ fixed coordinate system, reference voltages Vα* and Vβ* on the αβ axes, and an electrical angle θ, of the rotor. The fault detection core unit 100A_1 detects a fault, based on the counter electromotive force error Ver. The signal generation unit 100A_2 generates at least one of a shutdown signal and a notification signal, based on an error signal.

The vector control unit 100B performs typical calculation required for vector control. It should be noted that the vector control is a known technique; therefore, the specific description thereof will not be given here.

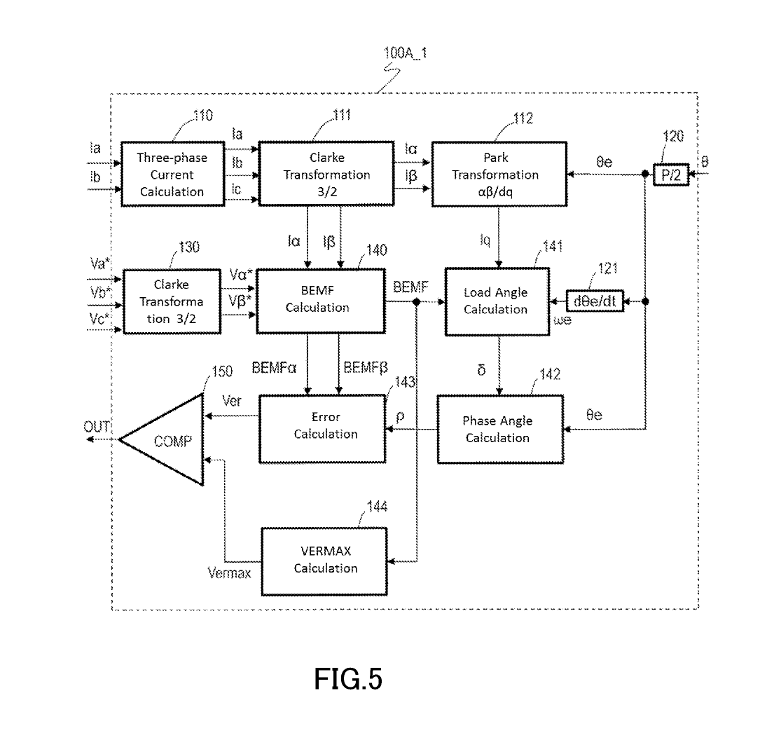

FIG. 5 schematically illustrates more specific functional blocks of the fault detection core unit 100A_1.

The fault detection core unit 100A_1 includes a three-phase current calculation unit 110, a Clarke transformation unit 111, a Park transformation unit 112, an angle conversion unit 120, an electrical angle differentiation unit 121, a Clarke transformation unit 130, a counter electromotive force calculation unit 140, a load angle calculation unit 141, a phase angle calculation unit 142, an error calculation unit 143, a maximum acceptable error calculation unit 144, and a level comparator 150.

In cases where the respective functional blocks are mounted as software in the controller 100, the software may be executed by, for example, a core of the controller 100. As described above, the controller 100 may be implemented with a FPGA. In this situation, all of or some of the functional blocks may be implemented by hardware. In addition, when the processing is executed in a decentralization manner using a plurality of FPGAs, load of calculation on a specific computer is decentralized. In this situation, all of or some of the functional blocks illustrated in FIG. 5 may be mounted in the plurality of FPGAs separately. The FPGAs are interconnected by, for example, an on-board control area network (CAN) to exchange data with one another.

As used herein, a current Iₐ flows through the U-phase wire of the motor M, a current I_{b} flows through the V-phase wire of the motor M, and a current I_{c} flows through the W-phase wire of the motor M. The currents Iₐ and I_{b} are detected by the current sensors 500A and 500B for the U-phase and V-phase wires. The current I_{c} is not detected by a current sensor, but is obtained by calculation. According to the three-phase energization control, a sum of the three-phase currents is zero. In other words, a relation to be satisfied is that a sum of the currents Iₐ, I_{b}, and I_{c} is zero.

The three-phase current calculation unit 110 receives two of the currents Iₐ, I_{b}, and I_{c}, and calculates a remaining one of the currents Iₐ, I_{b}, and I_{c}. In the first embodiment, the three-phase current calculation unit 110 acquires the current Iₐ measured by the current sensor 500A and the current I_{b} measured by the current sensor 500B. The three-phase current calculation unit 110 calculates the current I_{c}, based on the currents Iₐ and I_{b}, using the relation that the sum of the currents Iₐ, I_{b}, and I_{c} is zero. The three-phase current calculation unit 110 thus acquires the currents Iₐ, I_{b}, and I_{c}. As used herein, a value (e.g., the current I_{c}) to be acquired by calculation based on a value (e.g., the current Iₐ, I_{b}) actually detected by a sensor will also be called a “measured value”. The three-phase current calculation unit 110 outputs the measured currents Iₐ, I_{b}, and I_{c} to the Clarke transformation unit 111.

If the three current sensors are used for inputting the currents Iₐ, I_{b}, and I_{c} to the fault detection core unit 100A_1, the three-phase current calculation unit 110 may be omitted. The currents Iₐ, I_{b}, and I_{c} may also be acquired with this configuration.

The Clarke transformation unit 111 transforms the currents Iₐ, I_{b}, and I_{c} output from the three-phase current calculation unit 110, into a current Iα on the α axis and a current Iβ on the β axis in the αβ fixed coordinate system, by so-called Clarke transformation for use in, for example, the vector control. The αβ fixed coordinate system is a stationary coordinate system. The α axis extends in a direction of one of three phases (e.g., a U-phase direction), and the β axis extends in a direction perpendicular to the α axis. The Clarke transformation unit 111 outputs the currents Iα and Iβ to the Park transformation unit 112 and the counter electromotive force calculation unit 140.

The Park transformation unit 112 transforms the currents Iα and Iβ output from the Clarke transformation unit 111, into a current I_{d} on the d axis and a current I_{q} on the q axis in the dq rotating coordinate system, by so-called Park transformation for use in, for example, the vector control. This Park transformation is performed based on an electrical angle θₑ of the rotor. The dq rotating coordinate system refers to a rotating coordinate system that rotates together with a rotor. The Park transformation unit 112 outputs at least the current I_{q} to the load angle calculation unit 141.

The angle conversion unit 120 converts, into an electrical angle θₑ, a mechanical angle θₘ of the rotor measured by the angle sensor 700, based on Equation 1. The angle conversion unit 120 outputs the electrical angle θₑ to the Park transformation unit 112, the electrical angle differentiation unit 121, and the phase angle calculation unit 142.

θₑ=(P/2)·θₘ Equation (1)

In Equation (1), P represents the number of poles.

The electrical angle differentiation unit 121 time-differentiates the electrical angle θₑ to acquire an electrical speed ωₑ. The electrical speed ωₑ is an angular frequency of the electrical angle θₑ. The electrical angle differentiation unit 121 outputs the electrical speed ωₑ to the load angle calculation unit 141.

As in the Clarke transformation unit 111, the Clarke transformation unit 130 transforms reference voltages Vₐ*, V_{b}*, and V_{c}* into a reference voltage Vα* on the α axis and a reference voltage Vβ* on the β axis in the αβ fixed coordinate system, by the Clarke transformation. The reference voltages Vₐ*, V_{b}*, and V_{c}* respectively represent the PWM signals for controlling the switching elements in the inverter 300. The Clarke transformation unit 130 outputs the reference voltages Vα* and Vβ* to the counter electromotive force calculation unit 140.

The counter electromotive force calculation unit 140 calculates a component BEMFα on the α axis and a component BEMFβ on the β axis as to a counter electromotive force represented by a vector. More specifically, the counter electromotive force calculation unit 140 calculates a counter electromotive force BEMFα as a function of the current Iα and the reference voltage Vα*, based on Equation (2). In addition, the counter electromotive force calculation unit 140 calculates a counter electromotive force BEMFβ as a function of the current Iβ and the reference voltage Vβ*, based on Equation (2).

BEMFα=Vα*−R·Iα, BEMFβ=Vβ*−R·Iβ Equation (2)

In Equation (2), R represents an armature resistance. For example, the armature resistance R is set for the counter electromotive force calculation unit 140 by the core of the controller 100.

The counter electromotive force calculation unit 140 calculates a counter electromotive force absolute value BEMF, based on Equation (3). The counter electromotive force absolute value BEMF represents a magnitude of a counter electromotive force vector relative to the αβ fixed coordinate system or the dq rotating coordinate system.

BEMF=(BEMFα²+BEMFβ²)^{1/2} Equation (3)

The counter electromotive force calculation unit 140 outputs the component BEMFα on the α axis and the component BEMFβ on the β axis to the error calculation unit 143. The counter electromotive force calculation unit 140 outputs the absolute value BEMF to the load angle calculation unit 141 and the maximum acceptable error calculation unit 144.

The load angle calculation unit 141 calculates a load angle δ, based on Equation (4). The load angle calculation unit 141 outputs the load angle δ to the phase angle calculation unit 142. For example, the load angle δ is an angle between the counter electromotive force vector and the q axis in the dq rotating coordinate system with a counterclockwise direction defined as a positive direction.

δ=sin⁻¹(L_{q}·I_{q}·ωₑ/BEMF) Equation (4)

In Equation (4), L_{q} represents an armature inductance on the q axis in the dq rotating coordinate system.

The phase angle calculation unit 142 calculates a measured phase angle ρ, based on Equation (5). The phase angle calculation unit 142 outputs the measured phase angle ρ to the error calculation unit 143. The measured phase angle ρ is an angle between a composite magnetic flux Ψₛ and the α axis with the counterclockwise direction defined as the positive direction. For example, the composite magnetic flux Ψₛ represents a magnitude of a vector obtained by synthesis of a magnetic flux (vector) owing to a permanent magnet of a rotor with a magnetic flux (vector) generated by a wire of a stator.

ρ=θₑ+δ Equation (5)

The error calculation unit 143 calculates a counter electromotive force error Ver, based on Equation (6).

Ver=BEMFβ·cos ρ−BEMFα·sin ρ Equation (6)

The counter electromotive force error Ver is a scalar to be calculated with respect to the αβ fixed coordinate system. Alternatively, the counter electromotive force error Ver may be calculated with respect to the dq rotating coordinate system. In this situation, the scalar calculated with respect to the dq rotating coordinate system may be transformed into a value relative to the αβ fixed coordinate system. In a normal situation, an ideal value of the counter electromotive force error Ver is zero. As used herein, the “normal situation” refers to a situation in which none of the sensors fails in the motor drive system 1000.

The maximum acceptable error calculation unit 144 calculates a maximum acceptable error Vermax, based on Equation (7).

Vermax=K·BEMF Equation (7)

In Equation (7), K represents a predetermined constant. For example, the constant K is set by the core of the controller 100.

The level comparator 150 detects a level difference between the counter electromotive force error Ver and the maximum acceptable error Vermax. In other words, the level comparator 150 performs level comparison between the counter electromotive force error Ver and the maximum acceptable error Vermax. The level comparator 150 outputs an error signal indicating a sensor fault on condition that the counter electromotive force error Ver is equal to the maximum acceptable error Vermax or is larger than the maximum acceptable error Vermax. For example, the error signal is a digital signal. For example, an error signal level indicating a sensor fault may be allocated to “1”, and an error signal level not indicating a sensor fault may be allocated to “0”. In the example of allocation, the error signal is “0” in a normal situation, and is asserted to “1” upon occurrence of a sensor fault.

In the normal situation, the counter electromotive force error Ver is ideally zero. In practice, however, the counter electromotive force error Ver can take a value larger than zero. In consideration of this, in the first embodiment, adjusting the constant K to an appropriate value (e.g., 0.05) makes the counter electromotive force error Ver in the normal situation smaller than the maximum acceptable error Vermax. With this adjustment, no error signal is asserted. In other words, an error signal indicating occurrence of a sensor fault is not output from the fault detection core unit 100A_1 to the outside.

When at least one of the current sensors 500 as well as the angle sensor 700 fails, the counter electromotive force error Ver becomes equal to or more than the maximum acceptable error Vermax. Consequently, the error signal is asserted. In other words, an error signal indicating occurrence of a sensor fault is output from the fault detection core unit 100A_1 to the outside.

According to the first embodiment, the fault of the magnetic sensor or the like is detected using the calculations in Equations (1) to (7) that are much simpler than those of an extended Kalman filter. Therefore, the first embodiment enables a reduction in load of calculation for sensor fault detection on a computer. In other words, the first embodiment enables simplification of the algorithm for sensor fault detection, and consequently enables reductions in, for example, memory cost (system cost) and power cost.

Referring again to FIG. 4, the functional blocks of the controller 100 are described.

The fault detection core unit 100A_1 outputs an error signal to the signal generation unit 100A_2. When an error signal to be output from the level comparator 150 of the fault detection core unit 100A_1 is asserted to 1, the signal generation unit 100A_2 generates at least one of a shutdown signal and a notification signal in response to this assertion. The shutdown signal is a signal for stopping the motor drive system 1000, and is output to the shutdown circuit 400. The notification signal is a signal to be output to, for example, the lamp 800. For example, the lamp 800 blinks based on the notification signal to issue an alarm (call attention) to a driver as to occurrence of a sensor fault.

For example, consideration is given to a situation in which the motor drive system 1000 is used for an EPS system. In this situation, the shutdown signal stops the motor drive system 1000 to prevent erroneous operation of the motor drive system 1000 using an output value from a failed sensor (at least one of the current sensors 500A and 500B as well as the angle sensor 700). In addition, the notification signal causes an alarm lamp to light up and blink, so that the alarm lamp promptly issues an alarm to a driver as to occurrence of a fault. In accordance with the alarm, the driver safely pulls an automobile to, for example, the shoulder of a road while carefully performing a steering operation. As described above, the shutdown signal and the notification signal secure the safety of the driver.

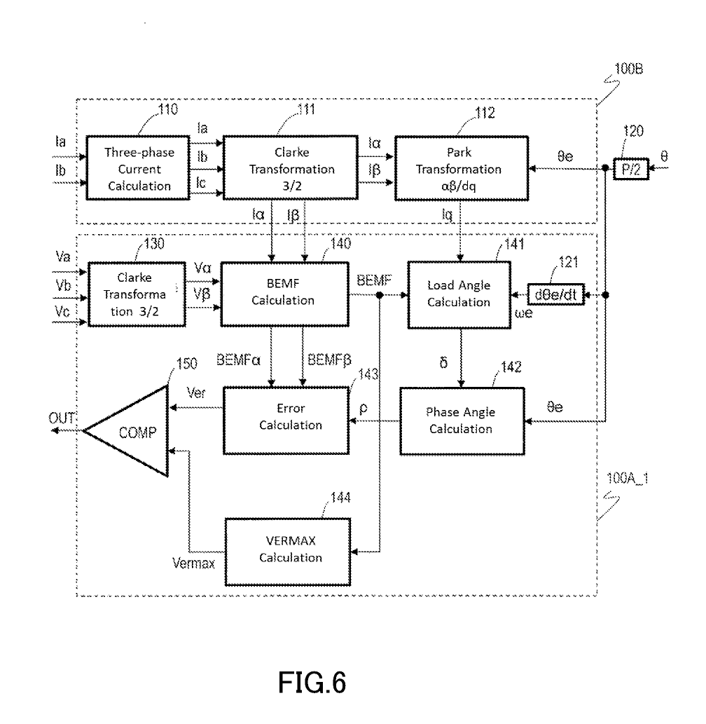

FIG. 6 schematically illustrates more specific functional blocks of the fault detection core unit 100A_1 according to a modification. FIG. 6 also illustrates some of functional blocks of the vector control unit 100B. In the vector control according to an embodiment of the present disclosure, two of the currents Iₐ, I_{b}, and I_{c} are used for calculating the remaining one current. In addition, the currents Iₐ, I_{b}, and I_{c} are transformed by Clarke transformation into the currents Iα and Iβ. The currents Iα and Iβ are transformed by Park transformation into currents I_{d} and I_{q}. Therefore, the vector control unit 100B includes a three-phase current calculation unit 110, a Clarke transformation unit 111, and a Park transformation unit 112, or units corresponding thereto.

As illustrated in FIG. 6, the counter electromotive force calculation unit 140 acquires currents Iα and Iβ output from the Clarke transformation unit 111 of the vector control unit 100B. In addition, the load angle calculation unit 141 acquires a current I_{q} output from the Park transformation unit 112 of the vector control unit 100B. As described above, the fault detection core unit 100A_1 generates an error signal indicating a sensor fault, using a part of data (signal) generated by the vector control unit 100B.

The following description concerns a result of verification using Matlab/Simulink available from MathWorks as to the validity of the algorithm for use in sensor fault detection according to the first embodiment. This verification was made using a model of a surface permanent magnet (SPM) motor. Table 1 shows values of various system parameters in the verification. In this verification model, the SPM motor is controlled by vector control. Table 2 shows variables for use in the vector control.

TABLE 1

| Moment of inertia | 6.9e⁻⁵ | [kg · m²] |
|---|---|---|
| Coefficient of friction | 5.1e⁻³ | [Nm/(rad/s)] |
| Resistance (motor + ECU) | 8.50 mΩ + 5.43 mΩ | |
| L_{d} (nominal) | 40.7 | μH |
| L_{q} (nominal) | 38.8 | μH |
| Voltage range | 10 to 16 | V |
| Temperature range | −40° C. to 90° C. | |
| Motor type | DC Brushless motor | |
| Number of poles | 8 | |
| Number of slots | 12 | |
| Maximum current | 77 | A |
| Rated voltage | 13.5 | V |
| Rated temperature | 80° | C. |
| Maximum torque | 5.96 | N · m |
| Wire diameter | ϕ1.45 | mm |

| | |
|---|---|
| Number of turns | 11.5 |

TABLE 2

| Reference I_{q} | 10.32 A/20.65 A | |
|---|---|---|
| Reference I_{d} | 0 | A |
| Speed | 750 | rpm |

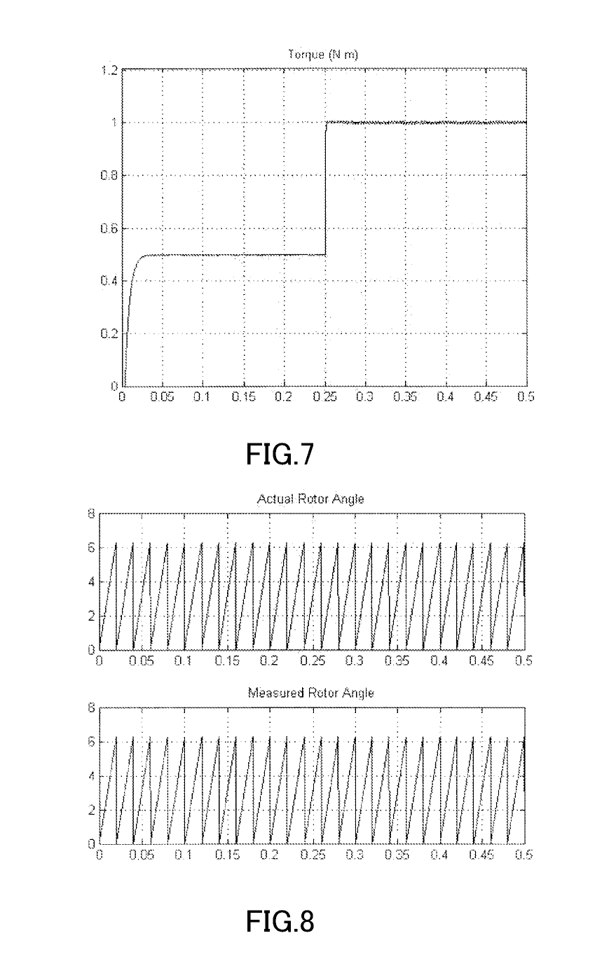

With reference to FIGS. 7 to 12, a description will be given of a result of simulation in the normal situation. In the following description, a case where no sensor fault occurs is referred to as a “first case”.

FIG. 7 illustrates a waveform of a torque within a predetermined period of time (0 seconds to 0.5 seconds) according to the first case. In FIG. 7, the vertical axis represents a torque (N·m), and the horizontal axis represents a time (s). As to simulated waveforms illustrated in FIGS. 8 to 30, the horizontal axis indicates a time (s). FIGS. 8 to 30 each illustrate a predetermined period of time from 0 seconds to 0.5 seconds.

FIG. 8 illustrates a waveform of an actual rotor angle and a waveform of a mechanical angle θₘ of the rotor, the mechanical angle θₘ being measured by the angle sensor 700, within the predetermined period of time according to the first case. In FIG. 8, the vertical axis represents the mechanical angle θₘ of the rotor.

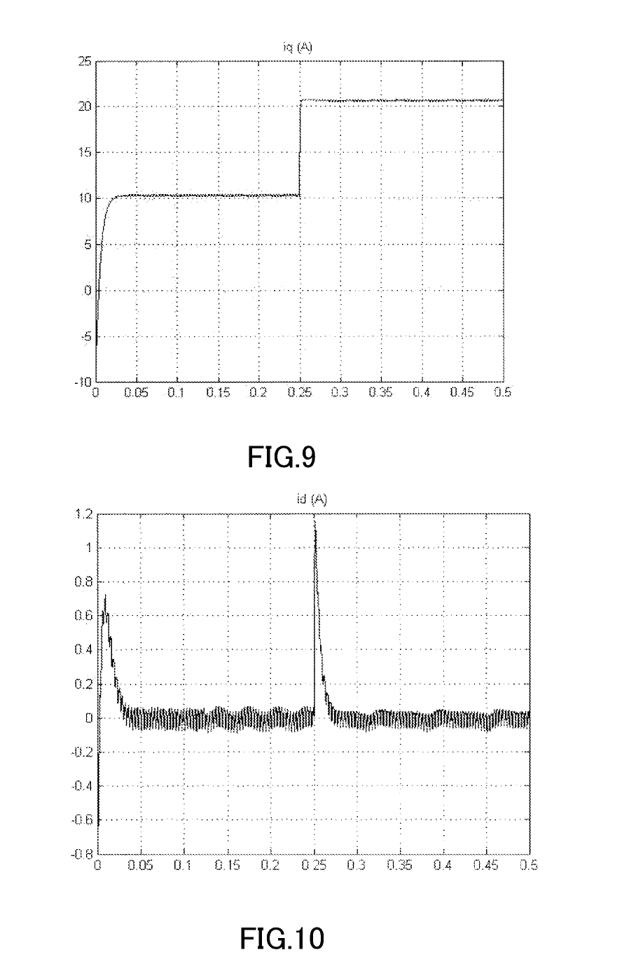

FIG. 9 illustrates a waveform of a current I_{q} within the predetermined period of time according to the first case. FIG. 10 illustrates a waveform of a current I_{d} within the predetermined period of time according to the first case. In FIG. 9, the vertical axis represents the current I_{q} (A). In FIG. 10, the vertical axis represents the current I_{d} (A).

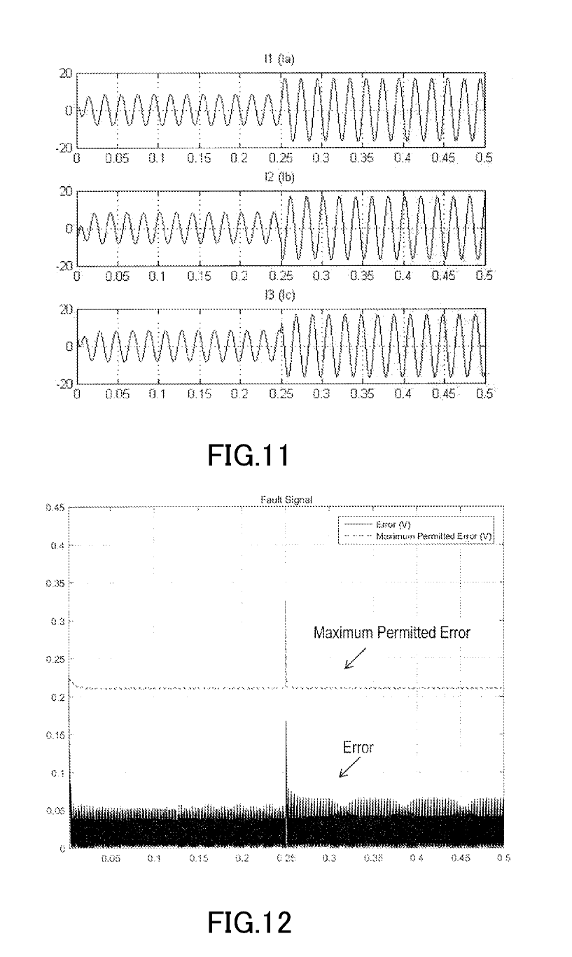

FIG. 11 illustrates waveforms of currents Iₐ, I_{b}, and I_{c} within the predetermined period of time according to the first case. In FIG. 11, the vertical axis represents the currents Iₐ, I_{b}, and I_{c} (A).

FIG. 12 illustrates a waveform of a counter electromotive force error Ver and a waveform of a maximum acceptable error Vermax, within the predetermined period of time according to the first case. In FIG. 12, the vertical axis represents the counter electromotive force error Ver (V) and the maximum acceptable error Vermax (V). In FIG. 12, “Error” indicates the counter electromotive force error Ver.

In the first case, since no sensor fault occurs, the vector control is sustained. As illustrated in FIG. 12, the counter electromotive force error Ver falls within a range smaller than the maximum acceptable error Vermax. As illustrated in FIG. 7, therefore, even when a torque fluctuates instantaneously at a time of, for example, 0.25 seconds, an error signal level is maintained at a value almost equal to zero. In other words, the error signal level is not asserted in the first case.

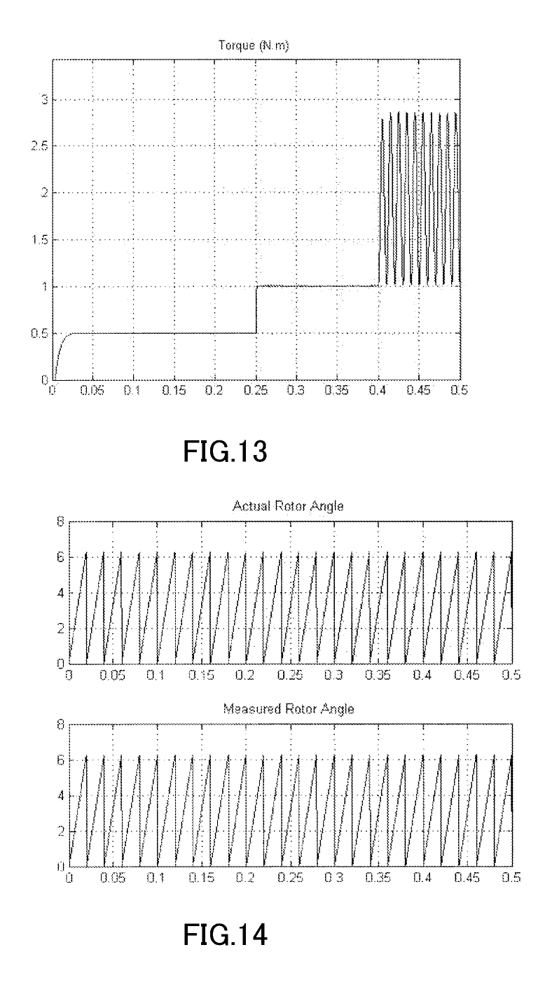

With reference to FIGS. 13 to 18, a description will be given of a result of simulation on condition that one of the two current sensors 500A and 500B fails. In the following description, a case where such a sensor fault occurs is referred to as a “second case”.

FIG. 13 illustrates a waveform of a torque within a predetermined period of time according to the second case. In FIG. 13, the vertical axis represents the torque (N·m).

FIG. 14 illustrates a waveform of an actual rotor angle and a waveform of a mechanical angle θₘ of the rotor, the mechanical angle θₘ being measured by the angle sensor 700, within the predetermined period of time according to the second case. In FIG. 14, the vertical axis represents the mechanical angle θₘ of the rotor.

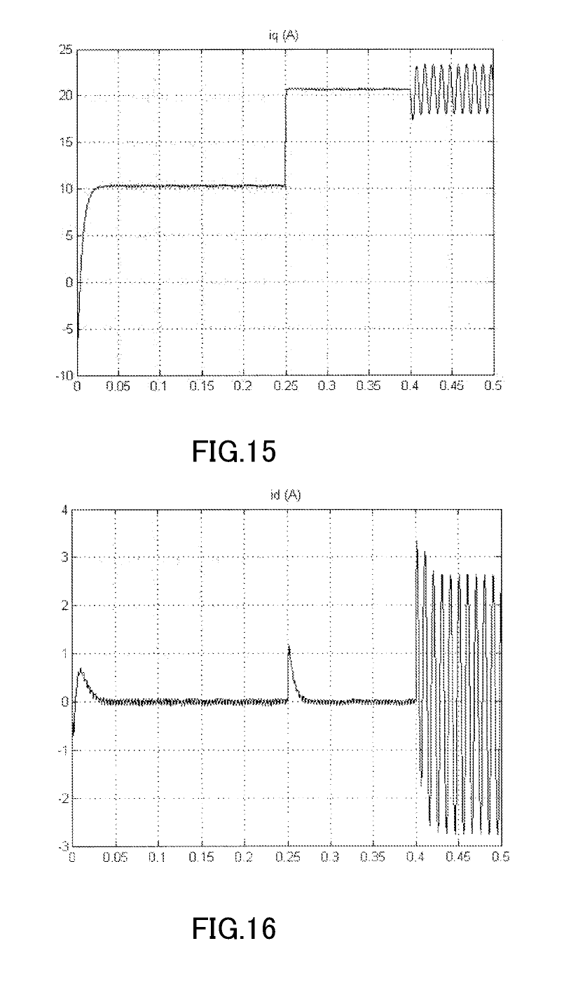

FIG. 15 illustrates a waveform of a current I_{q} within the predetermined period of time according to the second case. FIG. 16 illustrates a waveform of a current I_{d} within the predetermined period of time according to the second case. In FIG. 15, the vertical axis represents the current I_{q} (A). In FIG. 16, the vertical axis represents the current I_{d} (A).

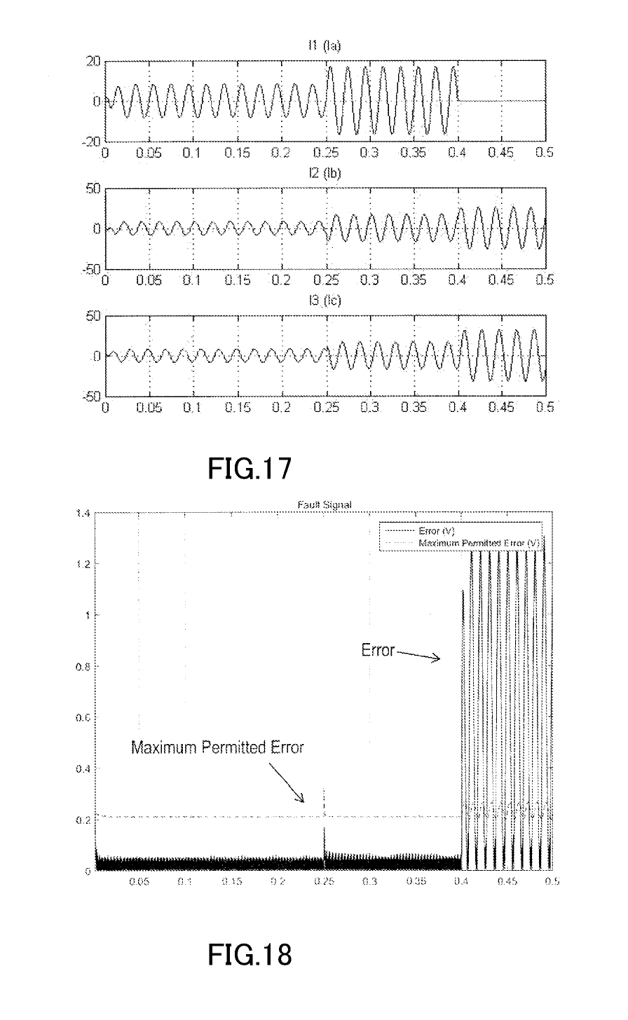

FIG. 17 illustrates waveforms of currents Iₐ, I_{b}, and I_{c} within the predetermined period of time according to the second case. In FIG. 17, the vertical axis represents the currents Iₐ, I_{b}, and I_{c} (A).

FIG. 18 illustrates a waveform of a counter electromotive force error Ver and a waveform of a maximum acceptable error Vermax, within the predetermined period of time according to the second case. In FIG. 18, the vertical axis represents the counter electromotive force error Ver (V) and the maximum acceptable error Vermax (V). In FIG. 18, “Error” indicates the counter electromotive force error Ver.

In the second case, an electrical connection between the motor drive system 1000 and the current sensor 500A that detects the current Iₐ is disconnected at a time of 0.4 s. This disconnection means that the current sensor 500A that detects the current Iₐ fails at the time of 0.4 s. As illustrated in FIG. 17, therefore, the current Iα is zero at and after the time of 0.4 s.

As illustrated in FIG. 18, before the time of 0.4 s at which the fault occurs, the counter electromotive force error Ver falls within a range smaller than the maximum acceptable error Vermax. If the fault occurs, the counter electromotive force error Ver becomes larger than the maximum acceptable error Vermax. In the second case, consequently, the error signal is asserted, which indicates that the sensor fault occurs.

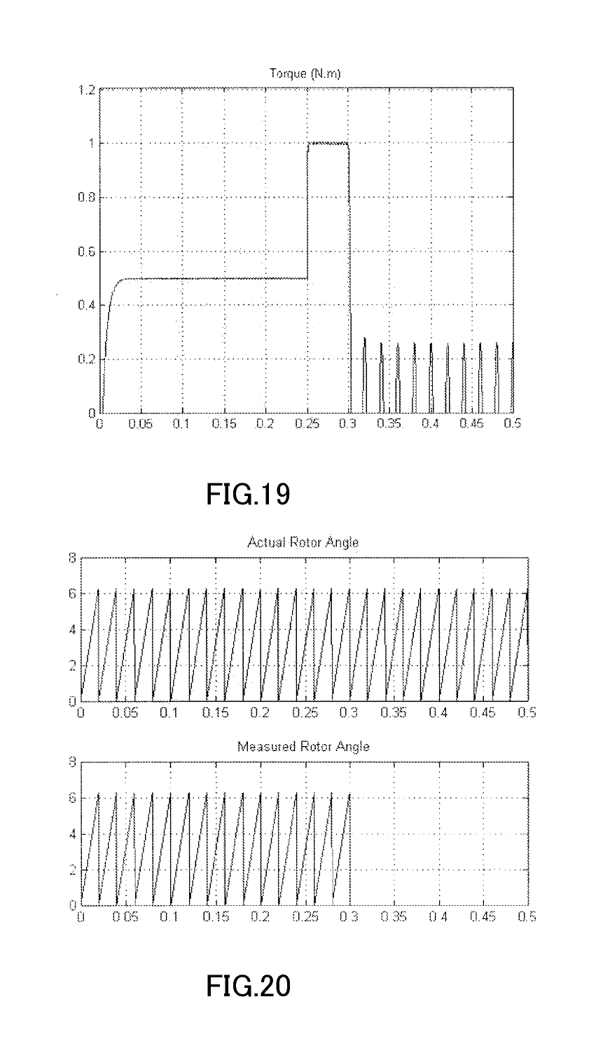

With reference to FIGS. 19 to 24, a description will be given of a result of simulation on condition that the angle sensor 700 fails. In the following description, a case where such a sensor fault occurs is referred to as a “third case”.

FIG. 19 illustrates a waveform of a torque within a predetermined period of time according to the third case. In FIG. 19, the vertical axis represents the torque (N·m).

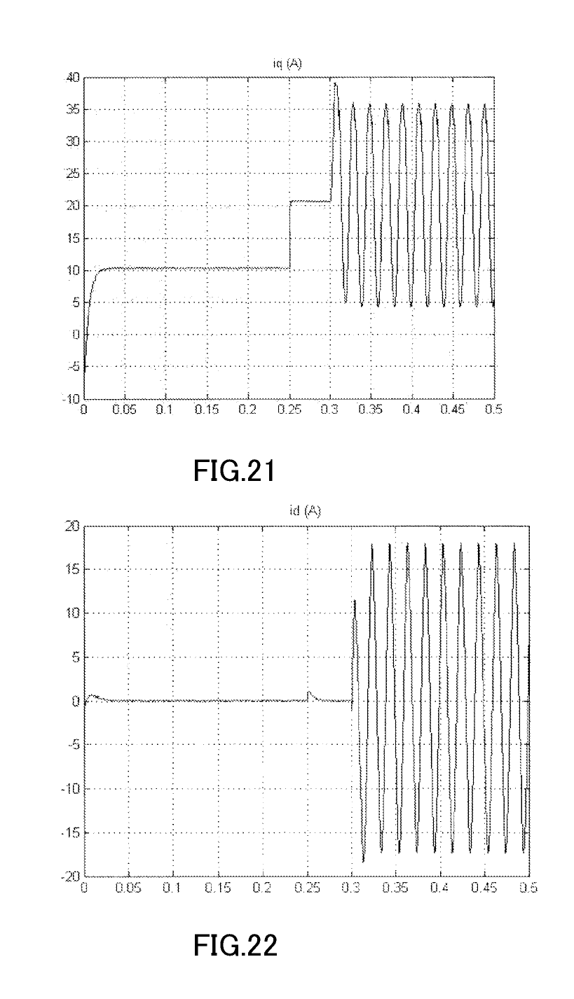

FIG. 20 illustrates a waveform of an actual rotor angle and a waveform of a mechanical angle θₘ of the rotor, the mechanical angle θₘ being measured by the angle sensor 700, within the predetermined period of time according to the third case. In FIG. 20, the vertical axis represents the mechanical angle θₘ of the rotor.

FIG. 21 illustrates a waveform of a current I_{q} within the predetermined period of time according to the third case. FIG. 22 illustrates a waveform of a current I_{d} within the predetermined period of time according to the third case. In FIG. 21, the vertical axis represents the current I_{q} (A). In FIG. 22, the vertical axis represents the current I_{d} (A).

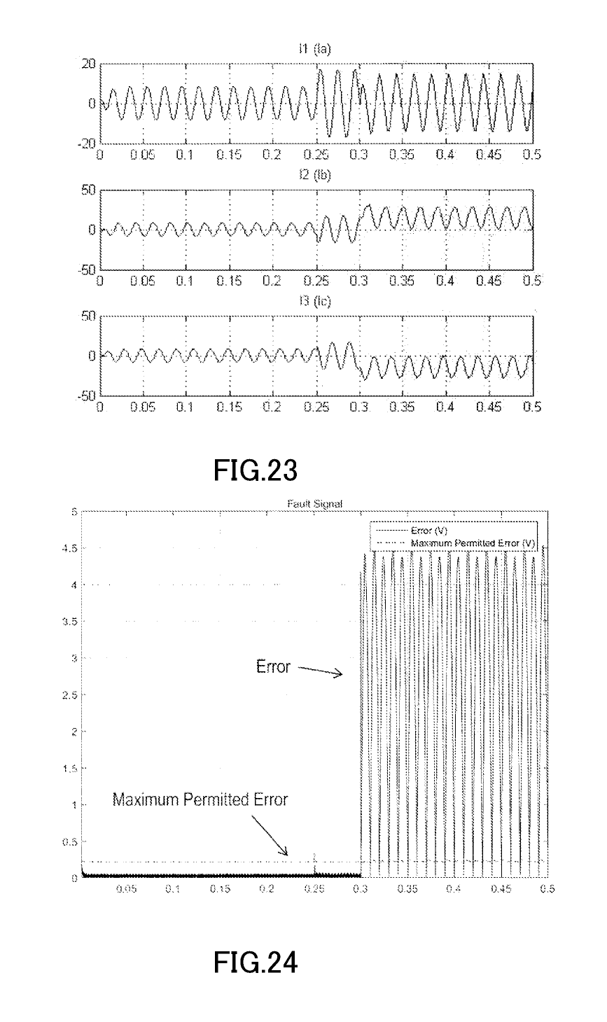

FIG. 23 illustrates waveforms of currents Iₐ, I_{b}, and I_{c} within the predetermined period of time according to the third case. In FIG. 23, the vertical axis represents the currents Iₐ, I_{b}, and I_{c} (A).

FIG. 24 illustrates a waveform of a counter electromotive force error Ver and a waveform of a maximum acceptable error Vermax, within the predetermined period of time according to the third case. In FIG. 24, the vertical axis represents the counter electromotive force error Ver (V) and the maximum acceptable error Vermax (V). In FIG. 24, “Error” indicates the counter electromotive force error Ver.

In the third case, an electrical connection between the motor drive system 1000 and the angle sensor 700 is disconnected at a time of 0.3 s. This disconnection means that the angle sensor 700 fails at the time of 0.3 s. As illustrated in FIG. 20, therefore, the mechanical angle θₘ of the rotor to be measured at and after the time of 0.3 s is zero.

As illustrated in FIG. 24, before the time of 0.3 s at which the fault occurs, the counter electromotive force error Ver falls within a range smaller than the maximum acceptable error Vermax. If the fault occurs, the counter electromotive force error Ver becomes larger than the maximum acceptable error Vermax. In the third case, consequently, the error signal is asserted, which indicates that the sensor fault occurs.

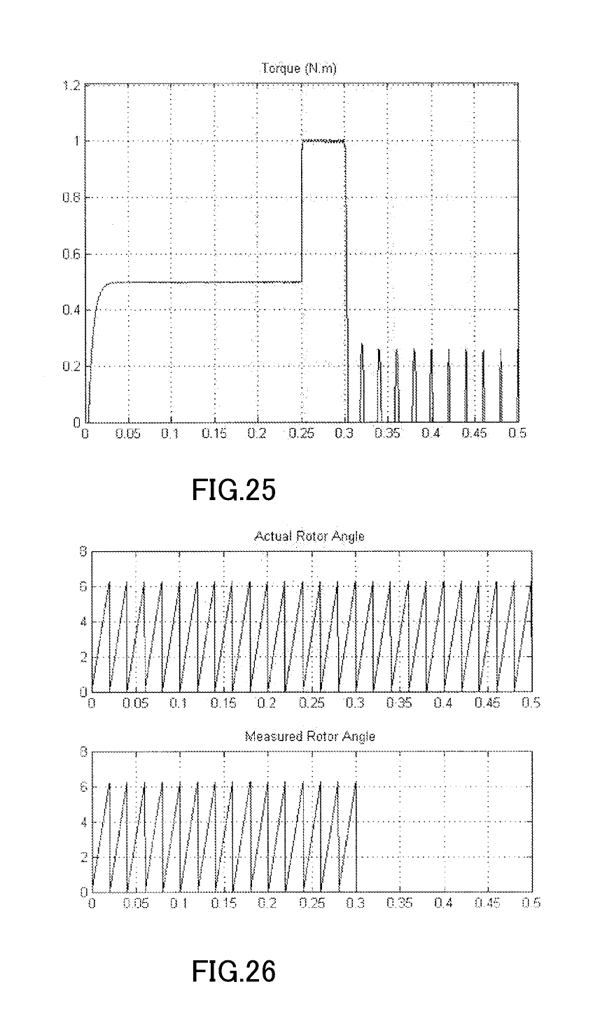

With reference to FIGS. 25 to 30, a description will be given of a result of simulation on condition that both the current sensor 500A and the angle sensor 700 fail. In the following description, a case where such a sensor fault occurs is referred to as a “fourth case”.

FIG. 25 illustrates a waveform of a torque within a predetermined period of time according to the fourth case. In FIG. 25, the vertical axis represents the torque (N·m).

FIG. 26 illustrates a waveform of an actual rotor angle and a waveform of a mechanical angle θₘ of the rotor, the mechanical angle θₘ being measured by the angle sensor 700, within the predetermined period of time according to the fourth case. In FIG. 26, the vertical axis represents the mechanical angle θₘ of the rotor.

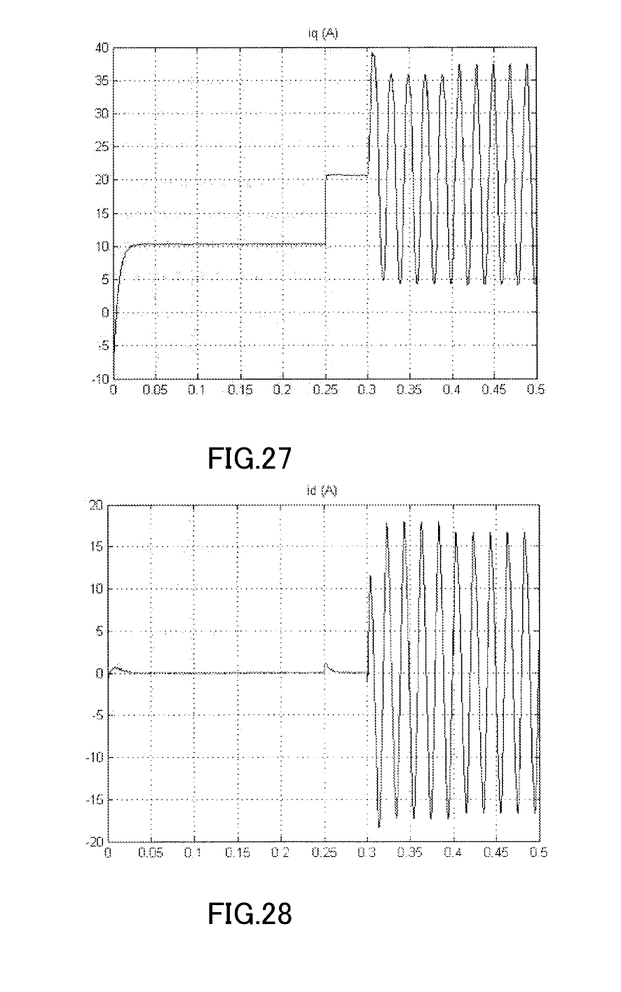

FIG. 27 illustrates a waveform of a current I_{q} within the predetermined period of time according to the fourth case. FIG. 28 illustrates a waveform of a current I_{d} within the predetermined period of time according to the fourth case. In FIG. 27, the vertical axis represents the current I_{q} (A). In FIG. 28, the vertical axis represents the current I_{d} (A).

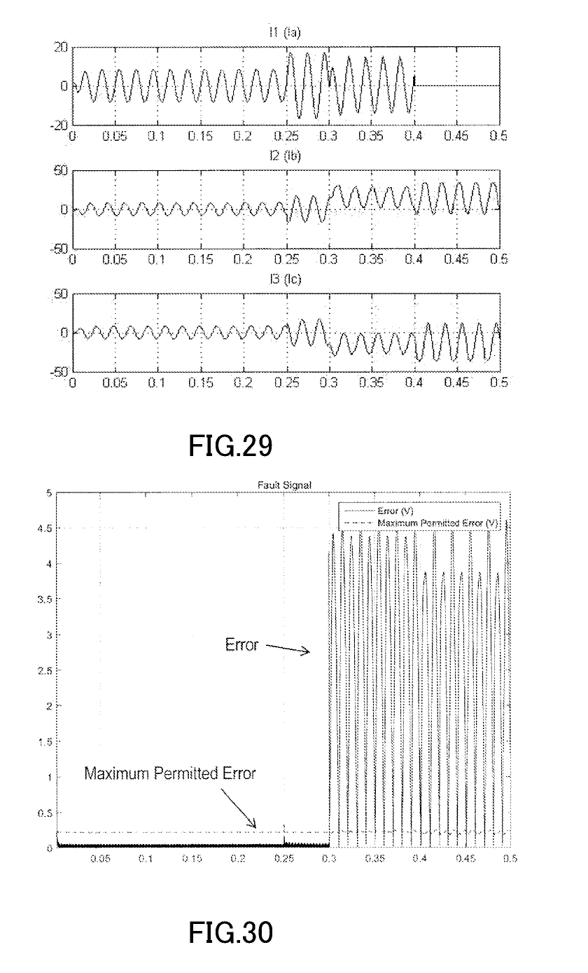

FIG. 29 illustrates waveforms of currents Iₐ, I_{b}, and I_{c} within the predetermined period of time according to the fourth case. In FIG. 29, the vertical axis represents the currents Iₐ, I_{b}, and I_{c} (A).

FIG. 30 illustrates a waveform of a counter electromotive force error Ver and a waveform of a maximum acceptable error Vermax, within the predetermined period of time according to the fourth case. In FIG. 30, the vertical axis represents the counter electromotive force error Ver (V) and the maximum acceptable error Vermax (V). In FIG. 30, “Error” indicates the counter electromotive force error Ver.

In the fourth case, first, the angle sensor 700 fails at a time of 0.3 s. As illustrated in FIG. 26, therefore, the mechanical angle θₘ of the rotor to be measured at and after the time of 0.3 s is zero. Next, the current sensor 500A that detects the current Iₐ fails at a time of 0.4 s. As illustrated in FIG. 29, therefore, the current Iₐ is zero at and after the time of 0.4 s.

As illustrated in FIG. 30, before the time of 0.3 s at which the former fault occurs, the counter electromotive force error Ver falls within a range smaller than the maximum acceptable error Vermax. If the former fault occurs, the counter electromotive force error Ver becomes larger than the maximum acceptable error Vermax. In the fourth case, consequently, the error signal remains asserted after the occurrence of the former fault, which indicates that the sensor fault occurs.

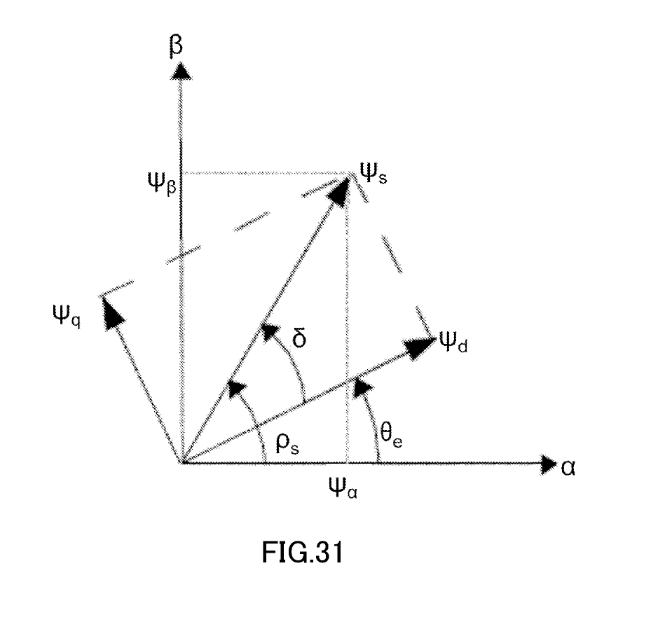

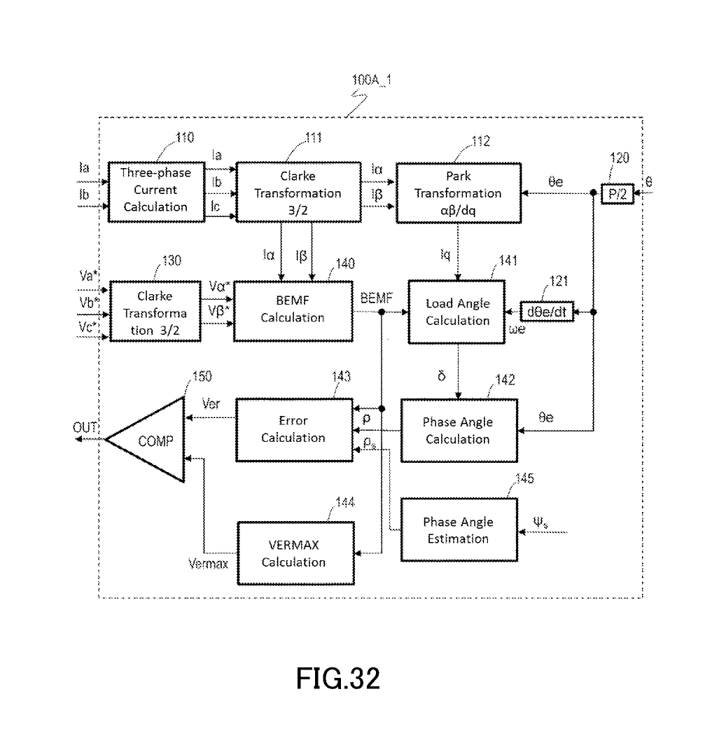

With reference to FIGS. 31 and 32, a description will be given of a method for detecting a sensor fault according to a second embodiment.

In the first embodiment, the counter electromotive force error Ver is represented by the function of the error between the estimated phase angle ρₛ and the measured phase angle ρ. Equation (6) described above is changed in accordance with a procedure to be described below, which makes it possible to understand the physical meaning of the counter electromotive force error Ver.

FIG. 31 illustrates a relationship between the composite magnetic flux Ψₛ and the estimated phase angle ρₛ.

First, Equation (8) is obtained by replacing p in Equation (6) with ρ′. In Equation (8), a relation of ρ′=90°−ρ is satisfied.

Ver=BEMFβ·cos ρ′−BEMFα·sin ρ′ Equation (8)

Equation (9) is obtained by dividing both the sides of Equation (8) by the absolute value BEMF.

Ver/BEMF=(BEMFβ/BEMF)·cos ρ′−(BEMFα/BEMF)·sin ρ′ Equation (9)

The composite magnetic flux Ψs is calculated based on the absolute value BEMF. In Equation (9), a relation of BEMF=Ψₛ·ωₑ is satisfied. In addition, a relation of BEMFα=dΨα/dt (d/dt: an operator indicating time differentiation) and a relation of BEMFβ=dΨβ/dt are satisfied. Based on these relations, Equation (9) is changed into Equation (10), using the composite magnetic flux Ψₛ.

Ver/BEMF=[{(dΨβ/dt)/ωₑ}/Ψₛ]·cos ρ′[{(dΨα/dt)/ωₑ}Ψₛ]·sin ρ′ Equation (10)

In Equation (10), Ψα represents a component of the composite magnetic flux Ψₛ on the α axis, and Ψβ represents a component of the composite magnetic flux on the β axis.

A relation of Ψα=(dΨβ/dt)/ωₑ and a relation of Ψβ=(dΨα/dt)/ωₑ are satisfied. Based on these relations, Equation (10) is further changed into Equation (11). Equation (12) is obtained by replacing ρ′ in Equation (11) with ρ.

Ver/BEMF=(Ψα/Ψₛ)·cos ρ′−(Ψβ/Ψₛ)·sin ρ′ Equation (11)

Ver/BEMF=(Ψα/Ψₛ)·sin ρ′−(Ψβ/Ψₛ)·cos ρ Equation (12)

The estimated phase angle ρₛ illustrated in FIG. 31 is estimated based on the composite magnetic flux Ψₛ. As illustrated in FIG. 31, a relation of ψₐ/Ψₛ=cos ρₛ and a relation of Ψβ/Ψₛ=sin ρₛ are satisfied. Equation (13) is finally obtained by changing Equation (12) with the use of these relations.

Ver=sin(ρ−ρₛ)·BEMF Equation (13)

Equation (13) indicates that the counter electromotive force error Ver is represented by the function of the error between the measured phase angle ρ and the estimated phase angle ρₛ. In the normal situation, the measured phase angle ρ is equal to the estimated phase angle ρₛ. The error in the normal situation shows a low level and is ideally zero. Hence, the low-level counter electromotive force error Ver indicates that no sensor fault occurs, whereas the high-level counter electromotive force error Ver indicates that a sensor fault occurs. The counter electromotive force error Ver may be calculated based on Equation (13) instead of Equation (6) described in the first embodiment. However, the calculation of the estimated phase angle ρₛ requires time. In addition, the calculation is complicated under lower-speed and higher-torque conditions, and therefore imposes load on a CPU. The reason therefor is an influence of DC offset. In contrast to this, according to the first embodiment, the counter electromotive force error Ver is calculated based on the error between the estimated phase angle ρₛ and the measured phase angle ρ. The first embodiment therefore requires no calculation of the estimated phase angle ρₛ. It is therefore preferable to calculate the counter electromotive force error Ver based on Equation (6) from the viewpoint of further reducing, for example, load on the CPU.

FIG. 32 schematically illustrates more specific functional blocks of the fault detection core unit 100A_1 according to the second embodiment.

The fault detection core unit 100A_1 further includes a phase angle estimation unit 145. The phase angle estimation unit 145 estimates the estimated phase angle ρₛ, based on the composite magnetic flux Ψₛ, and then outputs the estimated phase angle ρₛ to the error calculation unit 143. The composite magnetic flux Ψₛ is calculated based on the absolute value BEMF as described above. The error calculation unit 143 calculates the counter electromotive force error Ver, based on Equation (13), and then outputs the counter electromotive force error Ver to the level comparator 150.

The second embodiment requires no complicated calculation unlike an extended Kalman filter, and therefore enables a reduction in load of calculation for sensor fault detection on a computer, as in the first embodiment.

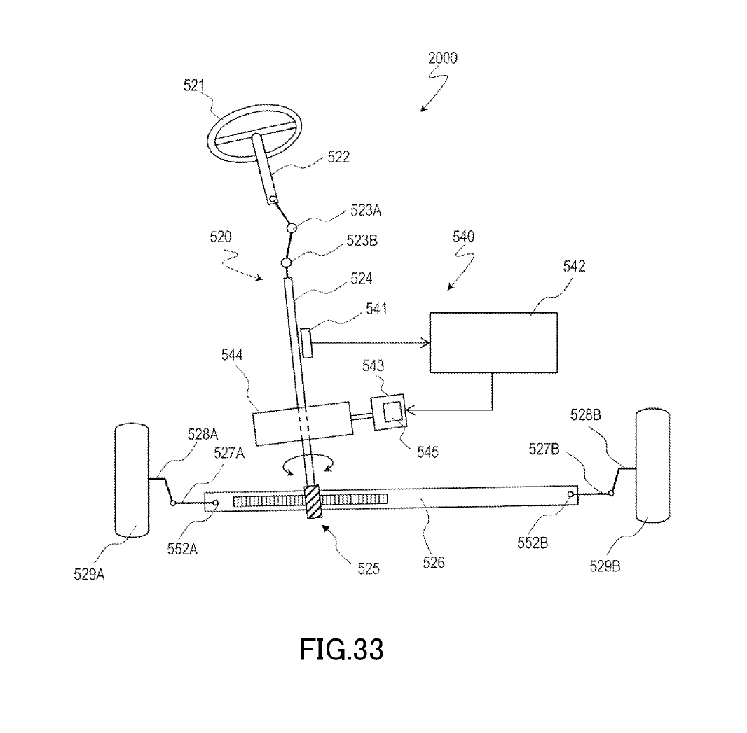

FIG. 33 schematically illustrates a typical configuration of an EPS system 2000 according to a third embodiment.

Typically, a vehicle such as an automobile is equipped with an EPS system. The EPS system 2000 according to the third embodiment includes a steering system 520, and an assist torque mechanism 540 that generates an assist torque. The EPS system 2000 generates an assist torque that assists a steering torque in a steering system, the steering torque being generated when a driver turns a steering wheel. The assist torque reduces a burden of a steering operation on the driver.

For example, the steering system 520 may include a steering wheel 521, a steering shaft 522, universal joints 523A and 523B, a rotating shaft 524, a rack and pinion mechanism 525, a rack shaft 526, left and right ball joints 552A and 552B, tie rods 527A and 527B, knuckles 528A and 528B, and left and right wheels 529A and 529B.

For example, the assist torque mechanism 540 includes a steering torque sensor 541, an automotive ECU 542, a motor 543, a speed reduction mechanism 544, and the like. The steering torque sensor 541 detects a steering torque in the steering system 520. The ECU 542 generates a drive signal based on a detection signal from the steering torque sensor 541. The motor 543 generates an assist torque responsive to the steering torque, based on the drive signal. The motor 543 transmits the assist torque to the steering system 520 via the speed reduction mechanism 544.

For example, the ECU 542 includes the controller 100, the drive circuit 200, and the like according to the first embodiment. In the automobile, the ECU serves as a core to constitute an electronic control system. In the EPS system 2000, for example, the ECU 542, the motor 543, and an inverter 545 constitute a motor drive system. The motor drive system 1000 according to the first embodiment may be suitably used as the motor drive system.

An embodiment of the present disclosure is suitably applicable to a motor drive system for a shift-by-wire motor, a steering-by-wire motor, a brake-by-wire motor, a traction motor, and the like each requiring an ability to detect a sensor fault. For example, a motor drive system according to an embodiment of the present disclosure is installable in a self-driving car compliant with Levels 0 to 4 (standards of automation) prescribed by the Japanese Government and the National Highway Traffic Safety Administration (NHTSA) of the United States Department of Transportation.

An embodiment of the present disclosure is widely applicable to a variety of apparatuses equipped with various motors, such as a vacuum cleaner, a dryer, a ceiling fan, a washing machine, a refrigerator, and an electric power steering system.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-17. (canceled)

18. A method for detecting a fault of at least one of a plurality of sensors in a motor drive system, the method comprising:
a step of performing a calculation (A) to determine a counter electromotive force error Ver relative to an αβ fixed coordinate system or a dq rotating coordinate system;
wherein
the calculation (A) is performed based on currents Iα and Iβ on αβ axes in the αβ fixed coordinate system, reference voltages Vα*and Vβ* on the αβ axes, and an electrical angle θₑ of a rotor;
the counter electromotive force error Ver represents a function of an error between an estimated phase angle ρₛ and a measured phase angle ρ based on sensor values to be measured by the sensors; and
the method further comprises a step of detecting the fault based on the counter electromotive force error Ver.

19. The sensor fault detection method according to claim 18, wherein the calculation (A) includes:
performing a calculation (a1) to determine a counter electromotive force BEMFα as a function of the current Iα and the reference voltage Vα*; and
performing a calculation (a2) to determine a counter electromotive force BEMFβ as a function of the current Iβ and the reference voltage Vβ*.

20. The sensor fault detection method according to claim 19, further comprising:
a step of acquiring three-phase reference voltages Vₐ*, V_{b}*, and V_{c}*; and
a step of transforming by Clarke transformation the three-phase reference voltages Vₐ*, V_{b}*, and V_{c}* into the reference voltages Vα* and Vβ*.

21. The sensor fault detection method according to claim 20, further comprising:
a step of acquiring three-phase currents Iₐ, I_{b}, and I_{c}; and
a step of transforming by Clarke transformation the three-phase currents Iₐ, I_{b}, and I_{c} into the currents Iα and Iβ.

22. The sensor fault detection method according to claim 20, further comprising:
a step of acquiring the mechanical angle θₘ of the rotor; and
a step of converting the mechanical angle θₘ of the rotor into an electrical angle θₑ of the rotor.

23. The sensor fault detection method according to claim 20, wherein the step of detecting the fault includes performing level comparison between the counter electromotive force error Ver and the maximum acceptable error Vermax.

24. The sensor fault detection method according to claim 23, wherein
the calculation (A) further includes performing a calculation (a3) to determine a counter electromotive force absolute value BEMF, based on Equation (1) of BEMF=(BEMFα²+BEMFβ²)^{1/2};
the calculation (a1) includes calculating the counter electromotive force BEMFα, based on Equation (2) of BEMFα=Vα−R·Iα, where R represents an armature resistance; and
the calculation (a2) includes calculating the counter electromotive force BEMFβ, based on Equation (3) of BEMFβ=Vβ−R·Iβ.

25. The sensor fault detection method according to claim 24, wherein the calculation (A) further includes a calculation (a4) to determine a load angle δ, based on Equation (4) of δ=sin⁻¹(L_{q}·I_{q}·ωe/BEMF), where I_{d} represents a current on a q axis in the dq rotating coordinate system, L_{q} represents an armature inductance the q axis, and ωₑ represents an electrical speed to be calculated as a time differentiation of the electrical angle θₑ of the rotor.

26. The sensor fault detection method according to claim 25, further comprising:
a step of transforming by Park transformation the currents Iα and Iβ into currents I_{d} and I_{d} on the dq axes.

27. The sensor fault detection method according to claim 25, wherein the calculation (A) further includes a calculation (a5) to determine the measured phase angle ρ, based on Equation (5) of ρ=θₑ−δ.

28. The sensor fault detection method according to claim 27, wherein the calculation (A) further includes a calculation (a6) to determine the counter electromotive force error Ver, based on Equation 6 of Ver=BEMFβ·cos ρ−BEMFα·sin ρ.

29. The method according to claim 27, wherein the calculation (A) further includes a calculation (a6′) to determine the counter electromotive force error Ver, based on Equation 7 of Ver=sin(ρ−ρₛ)·BEMF.

30. The sensor fault detection method according to claim 28, wherein the step of detecting the fault further includes calculation of the maximum acceptable error Vermax based on Equation 8 of Vermax=K·BEMF, where K represents a predetermined constant.

31. The sensor fault detection method according to claim 23, further comprising:
a step of outputting an error signal indicating the fault when the counter electromotive force error Ver is equal to or more than the maximum acceptable error Vermax.

32. The sensor fault detection method according to claim 31, further comprising:
a step of generating, in response to the error signal, at least one of a shutdown signal for shutting down the motor drive system and a notification signal for notifying a human.

33. A motor drive system comprising:
a motor including three-phase wires;
at least two current sensors to detect at least two of three-phase currents;
an angle sensor to detect a rotor angle of the motor; and
a controller configured or programmed to control the motor and to detect a fault of at least one of the at least two current sensors and the angle sensor; wherein
the controller calculates a counter electromotive force error Ver relative to an αβ fixed coordinate system or a dq rotating coordinate system, based on currents Iα and Iβ on αβ axes in the αβ fixed coordinate system, reference voltages Vα* and Vβ* on the αβ axes, and the rotor angle, the counter electromotive force error Ver representing a function of an error between an estimated phase angle ρₛ and a measured phase angle ρ based on sensor values to be measured by the two current sensors as well as the angle sensor; and
the controller detects the fault based on the counter electromotive force error Ver.

34. An electric power steering system comprising:
the motor drive system according to claim 33.
